(19) United States
(12) Patent Application Publication
(10) Pub. No.: US 2007/0074493 A1
(43) Pub. Date: Apr. 5, 2007

(54) Vertical pillow type packaging machine

(75) Inventors: Masashi Kondo, Ritto (JP); Makoto Ichikawa, Ritto (JP)

Correspondence Address: BEYER WEAVER LLP, P.O. BOX 70250, OAKLAND, CA, 94612-0250, US

(73) Assignee: ISHIDA Co., Ltd.

(21) Appl. No.: 11/607,415

(22) Filed: Dec. 1, 2006

Related U.S. Application Data
(62) Division of application No. 11/122,561, filed on May 4, 2005.
Application No. 11/122,561 is a continuation-in-part of application No. 10/871,821, filed on Jun. 17, 2004, now abandoned.

(30) Foreign Application Priority Data
Feb. 25, 2004 (JP) 2004-049575

(51) Int. Cl. B65B 9/06; B31C 13/00

(52) U.S. Cl. 53/551; 493/302; 493/308

(57) ABSTRACT

An article-supplying assembly for a vertical pillow type packaging machine has a first substantially cylindrical member extending vertically downward, a guiding member connected to the first substantially cylindrical member for guiding an elongated sheet of bag-making material from a front side to move downward along the first substantially cylindrical member, a second substantially cylindrical member inserted into the interior of the first substantially cylindrical member, and a funnel member for receiving articles falling from above. This funnel member is connected to the second substantially cylindrical member along a junction line, extending upward from the second substantially cylindrical member and allowing the received articles to fall through the first substantially cylindrical member downward. The junction line is at a highest point on the front side and at a lowest point on the backside. The ratio of the height difference between the highest and lowest points of the junction line with respect to the diameter of the cylindrical member is equal to or greater than 1.4.

This is a divisional of application Ser. No. 11/122,561 filed May 4, 2005, which is currently pending and is a continuation-in-part of application Ser. No. 10/871,821 filed Jun. 17, 2004, which is abandoned.

### BACKGROUND OF THE INVENTION

This invention relates to a form-fill-seal packaging machine of the so-called vertical pillow type.

Snack foods such as potato chips are usually packaged by means of a packaging machine of the so-called vertical pillow type. A packaging machine of the vertical pillow type is provided with a former such as described in Japanese Patent Publication Tokkai 7-315313, having a funnel-shaped tube placed above the former for guiding articles to be packaged. Recently, snack foods are coming to be sold in relatively small quantities. This means that bags for containing smaller quantities of food than before must be produced but since the average size of the articles to be packaged is not made any smaller simply because a smaller quantity of them is to be packaged, the ratio of the bag opening to the article size becomes smaller.

If the bag opening becomes smaller, an accordingly smaller tube must be employed to fill the bag with articles dropped from above. If the inner diameter of the tube is made smaller, however, the articles dropping therethrough are more likely to become clogged, sometimes by forming what are commonly referred to as bridges. It now goes without saying that such bridges formed inside the tube prevent a smoothly continuous packaging operation.

### SUMMARY OF THE INVENTION

It is therefore an object of this invention to provide a packaging machine designed such that articles do not become clogged so easily inside the article-guiding tube even while being dropped into a relatively small bag.

Article-supplying assemblies for a vertical pillow type packaging machine of this invention are comprised of a first substantially cylindrical member extending vertically downward, a guiding member connected to the first substantially cylindrical member for guiding an elongated sheet of bag-making material from a front side to move downward along the first substantially cylindrical member, a second substantially cylindrical member inserted into the interior of the first substantially cylindrical member, and a funnel member for receiving articles falling from above, this funnel member being connected to the second substantially cylindrical member along a junction line, extending upward from the second substantially cylindrical member and allowing the received articles to fall through the first substantially cylindrical member downward, wherein the junction line is at a highest point on the front side and at a lowest point on a back side opposite the front side, the ratio of the height difference between the highest and lowest points of the junction line with respect to the diameter of the cylindrical member being equal to or greater than 1.4.

The invention relates also to packaging machines of a so-called vertical pillow type comprised not only of any of such article-supplying assemblies characterized as above but also of a former which includes the guiding member and the first substantially cylindrical member, a longitudinal sealer for longitudinally sealing mutually overlapping side edges of the bag-making material into a tubular form, and a transverse sealer for transversely sealing the tubularly formed bag-making material and cutting the bag-making material transversely to separate an individual packaged product.

### BRIEF DESCRIPTION OF THE DRAWINGS

FIG. 1A is a schematic side view of a packaging machine embodying this invention, and FIG. 1B is a diagonal view of its former.

FIGS. 2A, 2B and 2C are schematic side views of three packaging machines embodying this invention for showing the positions of their collector structures and formers.

FIG. 3 is a schematic side view of a portion of another article-supplying assembly embodying this invention.

FIG. 4 is a schematic side view of a portion of still another article-supplying assembly embodying this invention.

### DETAILED DESCRIPTION OF THE INVENTION

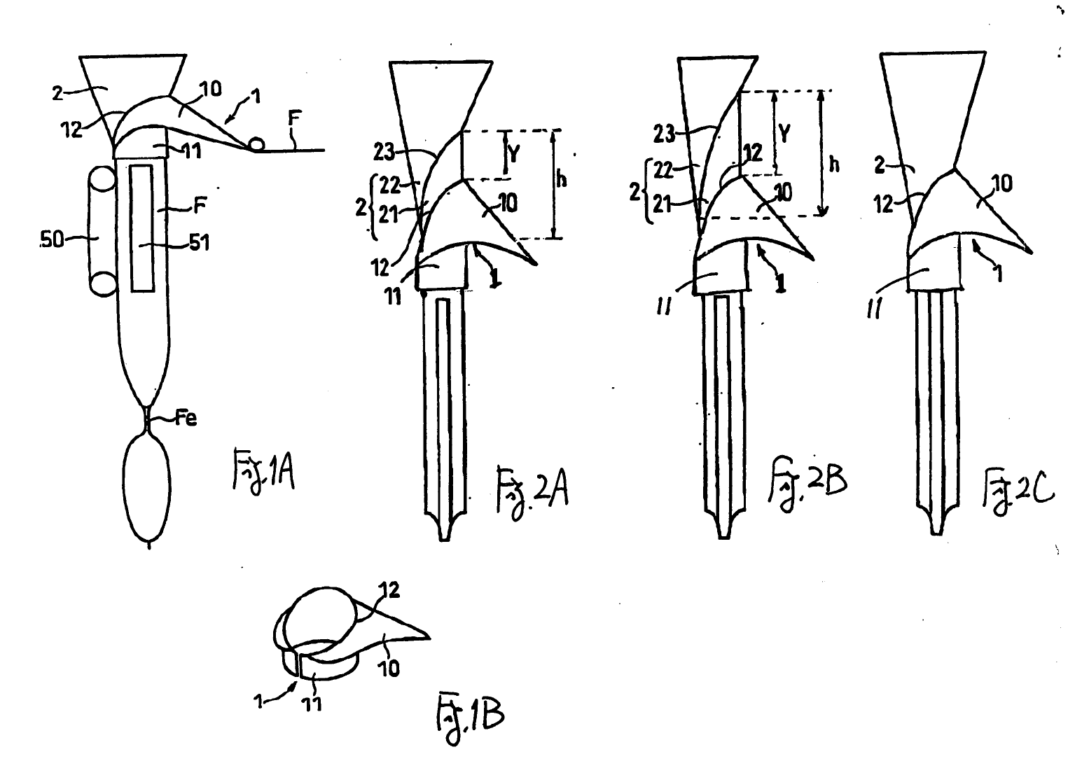

FIG. 1A shows a vertical pillow type packaging machine embodying this invention described, for example, in Japanese Patent Publication Tokkai 4-128105. An elongated sheet of bag-making material (the “film”) F unwound from a film roller (not shown) is made into a tubular form by means of a longitudinal sealer 50. As articles dropped from above fill the interior of the tubularly formed film F, an upper edge part Fe of the film F is sealed above the filled articles by means of an end sealer (not shown) and cut across such that packaged products are produced continuously at specified cycle times.

It is by means of a former 1 that the film F is bent into a tubular form. The packaging machine employs pull-down belts 51 to pull the film F downward while holding side surfaces of the film F by supplying a negative pressure in a known manner and the longitudinal sealer 50 seals over the mutually overlapping side edge parts of the film in the longitudinal direction.

As shown in FIG. 1B, the former 1 is comprised of a substantially cylindrical part 11 (hereinafter also referred to as the “first substantially cylindrical member”) with a C-shaped cross-section and a lapel-like guiding member 10 connected by welding to the cylindrical part 11. The line along which they are joined is hereinafter referred to as the ridgeline 12. The film F is guided by this guiding member 10 to the cylindrical part 11 and transported intermittently downward along the inner surface of the cylindrical part 11 from the position of the ridgeline 12 where the guiding member 10 and the cylindrical part 11 join. For the convenience of description, the side of the packaging machine from which the guiding member 10 protrudes horizontally and on which the bag-making material F is received by the former 1 is hereinafter defined as its front side. In FIG. 1A, therefore, the front side of the packaging machine is the right-hand side. The opposite side, which is to the left of FIG. 1A, is accordingly defined as its back side.

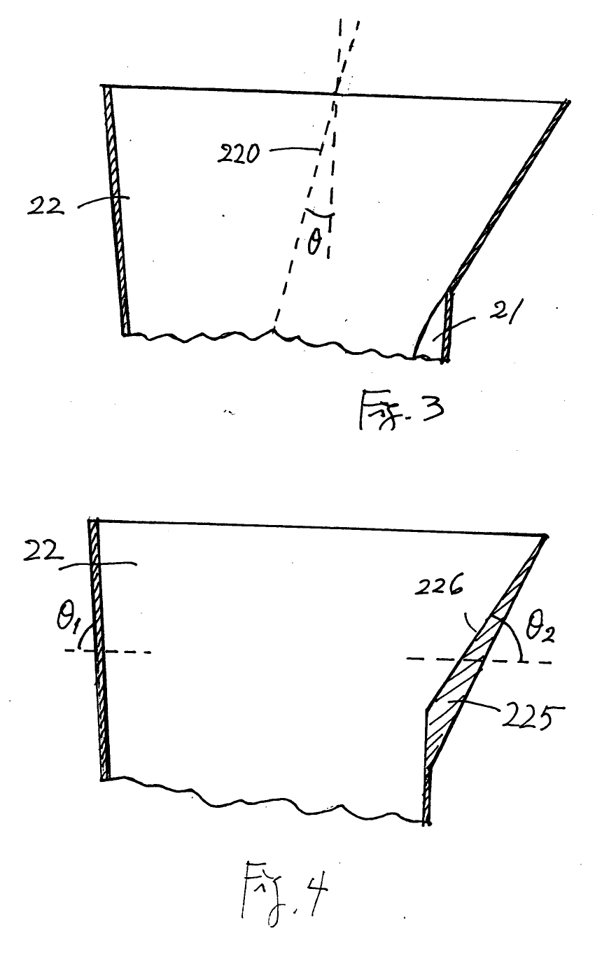

Portions of three examples of packaging machines with different designs embodying this invention are shown in FIGS. 2A, 2B and 2C (together referred to as FIG. 2). As shown in FIG. 2, a collector structure 2 is provided above the former 1, serving as a part of an article-supplying assembly for the packaging machine for collecting the articles intermittently dropped from above and to guide them into the interior of the cylindrical part 11. The collector structure 2 is comprised of another approximately cylindrical part 21 (hereinafter referred to as the “second substantially cylindrical member”) and a generally conically shaped part 22 (hereinafter referred to as the “funnel member”) of which the lower edge is welded to the upper edge of the second substantially cylindrical part 21 along a line (hereinafter referred to as the “junction line” 23). The funnel member 22 has its cross-sectional area becoming smaller from its upper to lower part. The outer diameter of the second substantially cylindrical part 21 at its lower end is smaller than the inner diameter of the first substantially cylindrical part 11 of the former 1 so as to be engagingly insertable into the upper end of the first substantially cylindrical part 11 of the former 1 and to pass the film (as shown in FIG. 1A) in between.

The former 1 and the collector structure 2 are fastened by means of a fastening tool (not shown) such that they are affixed to each other in a correctly positioned relationship according to this invention.

Article-supplying assemblies according to this invention may be characterized in different ways. According to one embodiment of the invention, the junction line 23 of the collector structure 2 and the ridgeline 12 of the former 1 along which the former 1 contacts the collector structure 2 are arranged such that not only is the junction line 23 always above the ridgeline 12 all around the second substantially cylindrical part 21 but also the height difference between them (shown by letter Y in FIGS. 2A and 2B) is greater on the front side than on the back side of the packaging machine. According to a preferable embodiment, furthermore, this height difference Y gradually increases from the back side to the front side, becoming the largest at the front side, also as shown in FIGS. 2A and 2B.

Effects of this aspect of the invention is explained next by way of three Test Examples (1, 2 and 3) and one Comparison Example, Text Examples 1 and 2 being as shown in FIG. 2A with Y=50 mm and 100 mm, respectively, Test Example 3 being as shown in FIG. 2B with Y=150 mm and Comparison Example being as shown in FIG. 2C with the ridgeline 12 nearly matching the junction line 23, that is, Y=0.

On each of these Comparison and Test Examples, the ratio h/D of the height difference h between the highest point on the junction line 23 on the front side and its lowest point on the back side with respect to the diameter D of the first substantially cylindrical part 11 was measured as a parameter. These ratios were 1.3, 1.7, 2.3 and 3.1 as shown in Table 1 below.

For all of the Examples above, the same former 1 as shown in FIG. 1B for producing bags of width about 133 mm (diameter being about 85 mm) was used. The collector structures 2 were all made of a transparent resin material such that a clogged condition could be visually observed. As articles to be packaged, about 20 g of potato chips with diameters about equal to 50 mm were dropped intermittently from a weighing apparatus placed above 500 times (for filling 500 bags) and the frequency of occurrence of clogging was recorded. The results of this test are also shown in Table 1.

TABLE 1

| | | | Height ratio | Frequency of |
|---|---|---|---|---|
| | Distance Y | | h/D | clogging |
| Comparison Example | 0 | | 1.3 | 12 times |
| Test Example 1 | 50 | mm | 1.7 | 5 times |
| Test Example 2 | 100 | mm | 2.3 | 5 times |
| Test Example 3 | 150 | mm | 3.1 | Once |

Table 1 shows clearly that clogging occurred frequently with Comparison Example but it was less than half with Test Examples 1, 2 and 3. It seems to indicate that the value of Y is preferably about 30 mm and ratio h/D should be greater than about 1.6.

Since Test Example 3 with Y=150 mm shows a significant decrease in the frequency of clogging but the processing efficiency is low, it is necessary to set Y less than about 170 mm (with h/D about equal to 3.1) and it is generally desirable to set Y to be less than 150 mm (with h/D about equal to 2.8).

In the above, the invention was explained by way of only a few examples but it should be clear to a person skilled in the art that many modifications and variations are possible within the scope of the invention. For example, there is no limitation intended on the diameter of the tube. Similar results may be expected for bags with width about 160 mm or less (corresponding to the tube diameter of about 102 mm or less). Thus, such modifications and variations are intended to be within the scope of the invention. The invention is applicable also for other kinds of pillow type packaging machines.

As remarked above, there is more than one way to characterize article-supplying assemblies of this invention. Since the clogging would be more likely to take place if all of the articles of a batch supplied together started to fall through the first substantially cylindrical part 11, the invention generally aims to cause some of the articles in a batch to start falling through the first substantially cylindrical part 11 by reaching the junction line 23 much sooner than some others, or to increase the effective sectional area through which the articles enter the first substantially cylindrical part 11. One way of accomplishing this is to tilt the funnel member 22 as shown enlarged in FIG. 3 wherein numeral 220 indicates the axis of symmetry of the funnel member 22 and θ indicates the angle between this axis of symmetry 220 with the vertical direction. FIG. 3 shows an example wherein the axis of symmetry of the funnel member 22 tilts in the direction of the front side such that the funnel has the most gently sloped slide line on the front side and the most steeply sloped slide line on the back side. The tilting angle θ of the axis of symmetry 220 is preferably in the range of 3°-12°. Although some prior art packaging machines employ a funnel-shaped article-receiving component with the axis of symmetry of its funnel-like shape tilted somewhat, it was at most the result of a design choice, not for the purpose of reducing the possibility of the occurrence of a clogged condition inside the cylindrical part 11 and hence the tilting angle of its axis of symmetry was at most about 2.5°. For the purpose of this invention, therefore, the tilting angle θ of the axis of symmetry 220 be required to exceed 2.5°.

FIG. 4 shows still another embodiment of this invention wherein the inner surface of the funnel member 22 has a thickened portion 225, say, on its front side, such that its inner surface is configured to have a pronouncedly more gently sloped upper portion 226. As can be understood by comparing FIGS. 3 and 4, such a thickened portion 225 with the inner surface thus configured has the same effect on the articles being supplied thereonto as tilting the funnel member 22 as a whole. Thus, if the sloping angle of the funnel member 22 on the back side is indicated by symbol θ₁ as shown in FIG. 4 and that of the more gently sloped upper portion 226 of the thickened portion 225 is indicated by symbol θ₂, their difference θ₁-θ₂ is greater than 5° (=2×2.5°), or preferably greater than 12° (=2×6°), and less than, say, 24° (=2×12°). The inventors do not claim to know exactly why these embodiments work but merely state that they have the desired effect of reducing the occurrence of clogged conditions probably because the articles supplied together are forced to start their free falls at different timings, depending on the lateral direction (such as from the front side or the back side) in which they reach the cylindrical part 11 to start falling freely.

In summary, many modifications and variations are possible within the scope of this invention and all such modifications and variations that may be apparent to a person skilled in the art are intended to be included within the scope of the invention.

What is claimed is:

1. An article-supplying assembly for a vertical pillow type packaging machine, said assembly comprising:
a first substantially cylindrical member extending vertically downward;
a guiding member connected to said first substantially cylindrical member for guiding an elongated sheet of bag-making material from a front side to move downward along said first substantially cylindrical member;
a second substantially cylindrical member inserted into the interior of said first substantially cylindrical member; and
a funnel member for receiving articles falling from above, said funnel member being connected to said second substantially cylindrical member along a junction line, extending upward from said second substantially cylindrical member and allowing said received articles to fall through said first substantially cylindrical member downward;
wherein said junction line is at a highest point on said front side and at a lowest point on a back side opposite said front side, the ratio of the height difference between said highest and lowest points of said junction line with respect to the diameter of said cylindrical member being equal to or greater than 1.4.

2. A packaging machine incorporating the article-supplying assembly of claim 1, said packaging machine comprising:
a former which includes said guiding member and said first substantially cylindrical member;
a longitudinal sealer for longitudinally sealing mutually overlapping side edges of said bag-making material into a tubular form; and
a transverse sealer for transversely sealing said tubularly formed bag-making material and cutting said bag-making material transversely to separate an individual packaged product.
